SEQUENCE LISTING (2 sequences)

SEQ ID NO: 1 - protein, 209 aa, Bos taurus
RELEELNVPGEIVESLSSSEESITRINKKIEKFQSEEQQQTEDELQDKIHPFAQTQSLVYPFPGPIPNSLPQNIPPLTQTPVVVPPFLQPEVMGVSKVKEAMAPKHKEMPFPKYPVEPFTESQSLTLTDVENLHLPLPLLQSWMHQPHQPLPPTVMFPPQSVLSLSQSKVLPVPQKAVPYPQRDMPIQAFLLYQEPVLGPVRGPFPIIV

SEQ ID NO: 2 - protein, 209 aa, Bos taurus
RELEELNVPGEIVESLSSSEESITRINKKIEKFQSEEQQQTEDELQDKIHPFAQTQSLVYPFPGPIHNSLPQNIPPLTQTPVVVPPFLQPEVMGVSKVKEAMAPKHKEMPFPKYPVEPFTESQSLTLTDVENLHLPLPLLQSWMHQPHQPLPPTVMFPPQSVLSLSQSKVLPVPQKAVPYPQRDMPIQAFLLYQEPVLGPVRGPFPIIV

(19) United States
(12) Patent Application Publication
(10) Pub. No.: US 2022/0400731 A1
(43) Pub. Date: Dec. 22, 2022

(54) A2-B-CASEIN CONTAINING COMPOSITION FOR PROMOTING AN IMPROVED TEMPERAMENT IN YOUNG MAMMALS

(71) Applicant: SOCIETE DES PRODUITS NESTLE S.A., Vevey (CH)

(72) Inventors: YIPU CHEN, La Tour-de-Peilz (CH); DOMINIK JOHANNES GRATHWOHL, La Tour-de-Peilz (CH); MANJIANG YAO, Pully (CH)

(21) Appl. No.: 17/755,004

(22) PCT Filed: Oct. 19, 2020
(86) PCT No.: PCT/EP2020/079301

§ 371 Date: Apr. 19, 2022

(30) Foreign Application Priority Data
Oct. 22, 2019 (EP) 19204723.1

(51) Int. Cl. A23L 33/19; A23L 33/00; A23L 33/135; A23L 33/21

(52) U.S. Cl. CPC A23L 33/19; A23L 33/40; A23L 33/135; A23L 33/21; A23V 2002/00

(57) ABSTRACT

The present invention relates to a nutritional composition for improving the temperament of young children. The nutritional composition for an infant or toddler comprises a2-β-casein, wherein the a2-13-casein represents more than 50%, preferably, more than 70%, more preferably, more than 90%, even more preferably, 95%, or most preferably 100% of total β-caseins. The composition has been clinically shown to improve the temperament in toddlers and young children.

### TECHNICAL FIELD OF THE INVENTION

The present invention relates to a nutritional composition including a growing up milk (GUM) comprising containing greater amounts of a2-β-casein compared to a1-β-casein for its use for promoting an improved temperament in young mammals.

### BACKGROUND OF THE INVENTION

Providing young mammals with the most appropriate nutritional support is of paramount importance, especially in earliest stages of life.

It is known that the nutrition administered to young mammals impacts many physiological parameters including not only growth and development, but also digestive comfort, response to allergens later in life and eve, to a certain degree cognitive function. Today, certain food ingredients are associated with irritability and low mood in young children. These food ingredients typically fall under the category of artificial coloring, sugar (in the form of sucrose and glucose), certain preservatives and of course, food allergens. However, even in avoiding these ingredients, some young children still tend to have frequent episodes of irritability, poor socialisation and are harder to sooth when they are upset. These children are may be globally considered as having a “poor temperament”). Having a “poor temperament” may be defined as being easily irritable, having poor sociability and poor soothability.

For example, a “poor temperament” in young child including toddlers and young children can lead initially to poor bonding and later a poor relationship between the child and the responsible care giver (for example, the parent). This may generate significant emotional problems for the child not only in the short term, but also later in life, for example, due to low self-confidence.

Given the potential long term impact that calming or improving a poor temperament in a young child may have for him (and his immediate entourage), later in life, it is extremely important to provide solutions towards improving poor temperament in young children, in particular infants and toddlers.

It is important that young children and their care givers can enjoy the young child's sociability, soothability (i.e. the ability to self sooth or to be soothed by a care giver), the ability to have few and shorter irritable periods.

The need exists to provide solutions that can improve the temperament of young children, in particular, of toddlers and young children up to the age of six years old.

The need exists to provide solutions that allows young mammals, in particular and toddlers and young children to self-sooth or to be soothed by a care giver.

The need exists to provide solutions that promotes sociability of young mammals, in particular in toddlers and young children.

The need exists to provide solutions that reduce the frequency and intensity of irritable episodes in young mammals, in particular, in in toddlers and young children.

The inventors have found that a particular mammalian milk ingredient, A2 variants of β-casein, can provide the above-described effects. A1 and A2 beta-casein are genetic variants of the beta-casein milk protein that differ by one amino acid.

Thus, “A2 milk” generally refers to a variety of cow's milk that mostly lacks a form of β-casein proteins called A1, and instead has mostly the A2 form. A2 cow's milk is commercially available from the a2 Milk Company (Auckland, New Zealand). Non-cow milk, including that of humans, sheep, goats, donkeys, yaks, camels, buffalo, and others, also contain mostly A2 β-casein, and so the term “A2 milk” is also used in that context.

The inventors have clinically proven that that, A2 milk and A2 milk derived products comprising a2-β-casein unexpectedly provide a temperament improving effect in young children that is not associated with gut comfort. In particular, the effect is seen for the A2 milk derived nutritional compositions, wherein the a2-β-casein represents more than 50%, preferably, more than 70%, more preferably, more than 90%, even more preferably, 95%, or most preferably 100% of total β-caseins.

### SUMMARY OF THE INVENTION

It is an object of the present invention to provide a nutritional composition comprising such as an infant formula, or growing up milk (GUM) which may improve the temperament of a young mammal, in particular of a human infant, toddler, or young child.

Thus, one aspect of the invention relates to a nutritional composition for an infant or toddler comprising a2-β-casein, wherein the a2-β-casein represents more than 50%, preferably, more than 70%, more preferably, more than 90%, even more preferably, 95%, or most preferably 100% of total β-caseins, for use in improving the temperament of a young mammal, in particular in toddlers and young children

According to an embodiment of the invention, the β-caseins are provided in the form of a whey protein fraction having a reduced β-casein derived proteose peptone content

According to an embodiment of the invention, said proteose peptone content is at the most 9% by weight based on total protein in the nutritional composition.

According to an embodiment of the invention, said proteose peptones are PP8 fast, PP8 slow and/or PP-5A.

According to an embodiment of the invention, the nutritional composition may be used to reducing the irritability of the infant, toddler or young child.

According to an embodiment of the invention, the nutritional composition may be used to increasing the ability of the infant, toddler or young child to self sooth or to be soothed by a care giver.

According to an embodiment of the invention, the nutritional composition may be used to increase the sociability of the infant, toddler or young child.

According to an embodiment of the invention, the nutritional composition also comprises one or more prebiotics.

According to an embodiment of the invention, the nutritional composition also comprises one or more probiotics.

According to an embodiment of the invention, the a2-β-casein is SEQ ID no 1.

### BRIEF DESCRIPTION OF THE FIGURES

FIG. 1 shows a schematic Mediation analysis for the effect of A2 GUM on Gut Comfort and Temperament. The mediation analysis showed that effect of A2 GUM on temperament is not influenced by the Gut Comfort variable (p=0.51).

FIG. 1A: c is the Total Effect from A2 on Temperament, including the possible residual effects from improvements in Gut Comfort.

FIG. 1B: c′(ADE) is the direct effect from A2 on Temperament. ACME is the mediation variable evaluating whether effects from A2 on temperament is influenced by Gut Comfort.

### DETAILED DESCRIPTION OF THE INVENTION

### Definitions

Prior to discussing the present invention in further details, the following terms and conventions will first be defined:

The term “A2 β-casein” refers to the A2 variant of bovine β-casein having the amino acid sequence according to SEQ ID NO. 1 (secreted form of protein). In the present context, other variants, which include a proline in position 67 may be included into A2 β-casein.

The term “A1 β-casein” refers to the A1 variant of bovine β-casein having the amino acid sequence according to SEQ ID NO. 2 (secreted form of protein). SEQ ID NO. 1 and SEQ ID NO. 2 only differ from each other in that A1 β-casein contains a histidine at position 67, whereas A2 β-casein contains a proline at position 67. In the present context, other variants, which include a histidine in position 67 may be included into A1 β-casein.

The term “intact β-casein” refers to the protein, which is not cleaved except for the removal of the signal sequence e.g. a protein as disclosed by SEQ ID NO. 1 and 2.

The term “WPC” refers to “whey protein concentrate”. In this context, WPC includes traditional WPC according to the USP definition as well as whey reduced in lactose and whey reduced minerals i.e. the protein level may be as low as 10% w/w.

The term “WPI” refers to “whey protein isolate” and is a whey protein concentrate having a whey protein content on a dry basis of not less than 90% by weight.

The term “whey protein fraction” refers to a composition comprising whey proteins e.g. WPC and/or WPI.

The term “standard SMP” refers to “standard skimmed milk powder” and is derived from milk obtained from mixed herds of cows and thus, comprises multiple variants of β-casein including A1 β-casein and A2 β-casein.

The term “A2 SMP” refers to “A2 skimmed milk powder” and comprises only A2 β-casein and not A1 β-casein.

The term “proteoform” refers to highly related protein molecules arising from all combinatorial sources of variation giving rise to products arising from a single gene. This includes products differing due to genetic variations, alternatively spliced RNA transcripts and post-translational modifications.

The term “proteose peptone” is the same as the one used in Swaisgood, 1982, i.e. the term “proteose peptone” refers to those proteins/peptides that remain in solution after milk has been heated at 95° C. for 20 minutes and then acidified to pH 4.7 with 12% trichloro-acetic acid.

The term “β-casein derived proteose peptones” refers to proteose peptones derived from β-casein alone such as PP-5, PP-8 fast and PP-8 slow.

The term “proteose peptone 5”, “PP5” or “PP-5” refers to the residues 1-105 and 1-107 derived from β-casein.

The term “proteose peptone 8 fast”, “PP8f” or “PP8 fast” refers to the residues 1-28 derived from β-casein. PP8 fast may also be referred to as “bcas4P 1-28”.

The term “proteose peptone 8 slow”, “PP8s” or “PP8 slow” refers to the residues 29-105 and 29-107 derived from β-casein. PP8 slow may also be referred to as “bcas1P 29-105” and “bcas1P 29-107”.

The term “infant” refers generally to a child under the age of 12 months; in one embodiment the meaning of the term may be extended to include children at any age up to and including 18 months, or at any age up to and including 24 months.

The term “toddler” refers generally to a child from the age from when he starts walking to about 36 months.

The term “young child” refers to a child from the age of 12 months to 6 years of age.

As used in this specification, the words “comprises”, “comprising”, and similar words, are not to be interpreted in an exclusive or exhaustive sense. In other words, they are intended to mean “including, but not limited to”.

As used herein, the term “nutritional composition” includes, but is not limited to, complete nutritional compositions, partial or incomplete nutritional compositions, nutritional supplements, and disease or condition specific nutritional compositions.

The term “nutritional supplement”, or “dietary supplement”, as used herein, refers to a nutritional product that provides nutrients to an individual that may otherwise not be consumed in sufficient quantities by said individual.

The term “food product”, as used herein, refers to any kind of product that may be safely consumed by a human or animal. Said food product may be in solid, semi-solid or liquid form and may comprise one or more nutrients, foods or nutritional supplements. For instance, the food product may additionally comprise the following nutrients and micronutrients: a source of proteins, a source of lipids, a source of carbohydrates, vitamins and minerals. The composition may also contain anti-oxidants, stabilizers (when provided in solid form) or emulsifiers (when provided in liquid form).

The term “infant formula”, as used herein, refers to a composition that is administered to infants and toddlers instead of, or, in addition to human milk. Infant formula (also known as “formula”) is defined by the U.S. Federal Food, Drug, and Cosmetic Act (FFDCA) as “a food which purports to be or is represented for special dietary use solely as a food for infants by reason of its simulation of human milk or its suitability as a complete or partial substitute for human milk”. It is also defined by the European Regulations, (COMMISSION DIRECTIVES, of 14 May 1991 on infant formulae and follow-on formulae (9 1/32 I/EEC)) and by guidelines issued by the Codex 15 Alimentarius STANDARD FOR INFANT FORMULA AND FORMULAS FOR SPECIAL MEDICAL PURPOSES INTENDED FOR INFANTS CODEX STAN 72-1981 Adopted as a worldwide Standard in 1981. Amendment: 1983, 1985, 1987, 2011 and 2015. Revision: 2007).

Infant formula may contain for example, cow's milk whey protein and casein as a protein source, a blend of vegetable oils as a fat source, lactose as a carbohydrate source, vitamin and mineral mixes, and other ingredients depending on the manufacturer. Infant formulas for infants who are allergic to other cow's milk proteins may contain soybean as a protein source in place of cow's milk, or may include partially or extensively hydrolysed cow's milk protein. Infant formulas may also be based on sheep, goat, camel or buffalo milk. Infant formulae may be especially formulated to meet the nutritional needs of infants in the first six months of life (starter formulas) or from six months onwards (follow-on formulas). Premature or low birthweight infants IF is also available for premature or low birthweight infants.

The term “Growing Up Milk” or “GUM” refers to (generally cow's) milk that has been fortified with iron or other minerals and vitamins; it is usually intended for administration to infants from the age of 12 months until they reach about 36 months.

The term “nutritional composition” means a composition, which nourishes a subject. This nutritional composition is usually to be taken orally or intravenously. It may include a lipid or fat source, a carbohydrate source and/or a protein source. The nutritional composition of the present invention can be in solid form (e.g. powder) or in liquid form.

In a particular embodiment, the composition of the present invention is a hypoallergenic nutritional composition. The expression “hypoallergenic nutritional composition” means a nutritional composition that is unlikely to cause allergic reactions.

In a particular embodiment, the nutritional composition of the present invention is a “synthetic nutritional composition”. The expression “synthetic nutritional composition” means a mixture obtained by chemical and/or biological means, which can be chemically identical to the mixture naturally occurring in mammalian milks (i.e. the synthetic nutritional composition is not breast milk). “Probiotic bacteria” means microbial cell preparations or components of microbial cells with a beneficial effect on the health or well-being of the host. A definition of probiotic bacteria is given in Salminen S et al. 1999.

“Prebiotic” means a selectively fermented ingredient that allows specific changes, both in the composition and/or activity in the gastrointestinal microflora that confers benefits upon host well-being and health. Prebiotica are discussed in Roberfroid MB 2007.

### Protein Component Comprising a2-β-casein

The nutritional compositions of the invention may generally contain a protein source in an amount of not more than 4.0, 3.0 or 2.1 g/100kcal, preferably 1.8 to 2.1 g/100kcal.

It is generally preferred that more 50% by weight of the protein source is whey.

In one embodiment, the protein content is between 30% and 80% whey proteins. Thus, protein sources based on whey, casein and mixtures thereof may be used as well as protein sources based on soy.

As far as whey proteins are concerned, the protein source may be based on acid whey or sweet whey or mixtures thereof and may include alpha-lactalbumin and beta-lactoglobulin in whatever proportions are desired.

In one embodiment of the invention, the nutritional composition comprises protein that is a mixture of whey protein and casein wherein the ratio of whey protein to casein is between 50:50 and 80:20, preferably 60:40.

For the casein proteins, the a1/a2 β-casein proportion is important generally. Specifically, the a2-β-casein (SEQ ID NO 1) represents more than 50%, preferably, more than 70%, more preferably, more than 90%, even more preferably, 95%, or most preferably 100% of total β-caseins present in the composition.

According on one embodiment of the invention, a2-β-casein represents more than 50% total β-caseins. According on one embodiment of the invention a2-β-casein represents more than 70% total β-caseins. According on one embodiment of the invention a2-β-casein represents more than 80% total β-caseins. According on one embodiment of the invention a2-β-casein represents more than 90% total β-caseins. According on one embodiment of the invention a2-β-casein represents more than 95% total β-caseins. According on one embodiment of the invention a2-β-casein represents 100% total β-caseins. In this case, no a1-β-casein (SEQ ID no 1) is present in the composition.

In general, the proteins may be intact or hydrolyzed or a mixture of intact and hydrolyzed proteins. It may be desirable to supply partially hydrolyzed proteins (degree of hydrolysis between 2 and 20%), for example for infants believed to be at risk of developing cows' milk allergy. If hydrolyzed proteins are used, the hydrolysis process may be carried out as desired and as is known in the art. For example, a whey protein hydrolysate may be prepared by enzymatically hydrolyzing the whey fraction in one or more steps. If the whey fraction used as the starting material is substantially lactose free, it is found that the protein suffers much less lysine blockage during the hydrolysis process. This enables the extent of lysine blockage to be reduced from about 15% by weight of total lysine to less than about 10% by weight of lysine; for example, about 7% by weight of lysine which greatly improves the nutritional quality of the protein source.

According to an embodiment of the invention, the nutritional compositions may comprise a whey protein fraction which has a reduced β-casein derived proteose peptone content. Available whey protein fractions to be used in formulation of nutritional compositions, including infant formulas and growing up milks often comprise A1 whey and/or A1A2 whey due to standard production methods. However, this has not previously been considered an issue e.g. for the manufacturing of A2 infant formula, because A1 β-casein would be precipitated during the preparation of the whey and thus, not be part of the whey protein fraction. However, it has been shown in EP application number 18214628.2 that proteose peptones derived from A1 β-casein are detected in whey protein fractions such as WPC.

Therefore, advantageously, the nutritional composition may comprise a whey protein fraction having a reduced β-casein derived proteose peptone content. Such a whey protein fraction may be provided by a method comprising the steps of:
(i) providing a whey protein fraction;
(ii) determining and quantifying said β-casein derived proteose peptones in said whey protein fraction as described herein; and
(iii) selecting said whey protein fraction having at the most 10% by weight of β-casein derived proteose peptones based on the total protein in said whey protein fraction forming a selected whey protein fraction.

Methods to carry out these steps are described in EP application number 18214628.2.

According to these methods, the content of β-casein derived proteose peptones including β-casein variants and proteoforms may be easily detected and quantified. Thus, the whey protein fractions may be separated into whey protein fractions containing different amounts of proteose peptones. Thus, whey protein fractions may be selected that comprise, at the most, 10% by weight of proteose peptones out of the total amount of proteins in the whey protein fraction.

In one embodiment, the selected whey protein fraction has a β-casein derived proteose peptone content, such as a β-casein derived proteose peptone content, of, at the most, 9.5% by weight, such as, at the most, 9% by weight, preferably, at the most, 8.5% by weight, such as, at the most, 8% by weight, more preferably, at the most, 7.5% by weight, such as, at the most, 7% by weight, even more preferably, at the most, 6.5% by weight, such as, at the most, 6% by weight, still more preferably, at the most, 5.5% by weight, such as, at the most, 5% by weight, most preferably, at the most, 4.5% by weight, such as, at the most, 4% by weight, at the most, 3.5% by weight, such as, at the most 3% by weight, preferably, at the most, 2.5% by weight, such as, at the most, 2% by weight, more preferably, at the most, 1.5% by weight, such as, at the most, 1% by weight, even more preferably, at the most, 0.75% by weight, such as, at the most, 0.50% by weight, still more preferably, at the most, 0.25% by weight, such as, at the most, 0.10% by weight, most preferably, at the most, 0.05% by weight, such as, at the most, 0.01% by weight, based on total protein in the whey protein fraction.

The total amount of protein in the whey protein fraction is preferably measured by Kjeldahl analyses (ISO 8968-1:2014).

In one embodiment, the proteose peptones are PP8 fast, PP8 slow and/or PP-5. In a further embodiment, the proteose peptones are PP8 slow and/or PP-5.

In one embodiment, the selected whey protein fraction has a PP8 slow and/or PP-5 content, of, at the most, 9.5% by weight, such as, at the most, 9% by weight, preferably, at the most, 8.5% by weight, such as, at the most, 8% by weight, more preferably, at the most, 7.5% by weight, such as, at the most, 7% by weight, even more preferably, at the most, 6.5% by weight, such as, at the most, 6% by weight, still more preferably, at the most, 5.5% by weight, such as, at the most, 5% by weight, most preferably, at the most, 4.5% by weight, such as, at the most, 4% by weight, at the most, 3.5% by weight, such as, at the most 3% by weight, preferably, at the most, 2.5% by weight, such as, at the most, 2% by weight, more preferably, at the most, 1.5% by weight, such as, at the most, 1% by weight, even more preferably, at the most, 0.75% by weight, such as, at the most, 0.50% by weight, still more preferably, at the most, 0.25% by weight, such as, at the most, 0.10% by weight, most preferably, at the most, 0.05% by weight, such as, at the most, 0.01% by weight, based on total protein in the whey protein fraction.

In a still further embodiment, the proteose peptone is PP-5.

The nutritional composition of the invention may be intended for any mammal, such as for example humans, and pets such as cats and dogs. In a preferred embodiment, the mammal is a human. In a preferred embodiment, the human is an infant of greater than 12 months old and less than 6 years old.

Examples of nutritional compositions are follow on infant formula, growing up milk and dairy products suitable for young children.

In one embodiment, the nutritional composition is a follow on infant formula suitable for infants of more than 12 months old.

In one embodiment, the nutritional composition is a growing up milk (GUM).

A number of a2-β-casein containing milk products are available commercially today and these may be suitable for the use according to an embodiment of the invention. One may cite, for example, “Illuma Atwo Stage 3” available from WYETH (USA). The nutritional composition of this product is given in Example 2 below. Another example of a commercially available a2-β-casein containing milk product is a2 Platinum® Toddler milk drink available from A2 Milk company, Auckland New Zealand. The nutritional composition of this product is given in Example 3 below. Another example of a commercially available a2-β-casein containing milk product is “Illuma Atwo Stage 2” available from WYETH (USA). The nutritional composition of this product is given in Example 4 below.

The general composition of a nutritional composition such as an infant formula for use according to the present invention may optionally contain substances which may have a beneficial effect such as probiotic bacteria, fibres, lactoferrin, nucleotides, nucleosides, and/or the like in the amounts such as those customarily found in nutritional compositions to be fed to infants.

The probiotic bacteria may be selected from the group consisting of Lactobacillus such as Lactobacillus rhamnosus, Lactobacillus paracasei and Lactobacillus reuteri and Bifidobacterium such as Bifidobacterium lactis, Bifidobacterium breve and Bifidobacterium longum.

The nutritional composition, such as the follow on infant formula or growing up milk, may optionally further comprise prebiotics, such as nondigestable carbohydrates that promote the growth of probiotic bacteria in the gut.

In a preferred embodiment, nutritional composition, such as follow on infant formula or growing up milk, comprises prebiotics selected from the group consisting of fructooligosaccharides (FOS), raftilose, inulin, raftiline, lactulose, cows' milk oligosaccharides (CMOS) and galactooligosaccharides (GOS), human milk oligosaccharides (CMOS).

The nutritional composition may also contain all vitamins and minerals understood to be essential in the daily diet in nutritionally significant amounts.

Thus, a preferred embodiment relates to a nutritional composition, such as a follow on infant formula or growing up milk (GUM), further comprising vitamins.

Minimum requirements have been established for certain vitamins and minerals. Examples of minerals, vitamins and other nutrients optionally present in the nutritional composition include vitamin A, vitamin B1, vitamin B2, vitamin B6, vitamin B12, vitamin E, vitamin K, vitamin C, vitamin D, folic acid, inositol, niacin, biotin, pantothenic acid, choline, calcium, phosphorous, iodine, iron, magnesium, copper, zinc, manganese, chloride, potassium, sodium, selenium, chromium, molybdenum, taurine, and L-carnitine. Minerals are usually added in salt form.

If necessary, the nutritional composition, such as a follow on infant formula or GUM, may contain emulsifiers and stabilizers such as soy lecithin, citric acid esters of mono- and di-glycerides, and the like. This is especially the case if the composition is provided in liquid form.

Another preferred embodiment relates to a nutritional composition, such as a follow on infant formula or GUM, further comprising anhydrous milk fat.

A yet other preferred embodiment relates to a nutritional composition, such as a follow on infant formula or GUM, further comprising LC-PUFAs. Examples of LC-PUFA that may be added are docosahexaenoic acid (DHA), arachidonic acid (ARA) and EPA. The LC-PUFA may be added at concentrations so that they constitute greater than 0.01% of the total FA present in the composition. LC-PUFA containing oils may thus be present in an amount of about 0.2%-2% of the total lipid amount in the composition such as DHA, EPA, DPA and/or ARA.

### Probiotics

In a preferred embodiment, probiotics may be included in the nutritional compositions of the invention. Examples of known probiotic compounds are Bacillus, Bifidobacterium, Lactobacillus, Lactococcus, Enterococcus, Saccharomyces, Kluyveromyces, Candida, Streptococcus, in particular selected from the group consisting of Bifidobacterium longum, Bifidobacterium lactis, Bifidobacterium animalis, Bifidobacterium breve, Bifidobacterium infantis, Bifidobacterium adolescentis, Lactobacillus acidophilus, Lactobacillus casei, Lactobacillus paracasei, Lactobacillus salivarius, Lactobacilluslactis, Lactobacillus reuteri, Lactobacillus rhamnosus, Lactobacillus johnsonii, Lactobacillus plantarum, Lactococcus lactis, Streptococcus thermophilus, Enterococcusfaecium, Saccharomyces cerevisiae, Saccharomyces boulardii, E. Coli Nissle. In particular, probiotics and non-replicating probiotics, such as the genus Lactobacillus, Bifidobacterium or combination thereof, for example Lactobacillus johnsonii, Lactobacillus paracasei, Lactobacillus rhamnosus, Bifidobacterium longum, Bifidobacterium lactis, Bifidobacterium breve, or combination thereof, and applications of these bacteria.

### Carbohydrates

A preferred embodiment relates to a nutritional composition, such as a follow on infant formula or GUM, wherein at least one source of carbohydrates is selected form the group consisting of lactose, corn syrup solids, fructose, glucose, maltodextrins, dried glucose syrups, sucrose, trehalose, galactose, maltose, honey powders, starch, oligosaccharides, raftiline and raftilose.

Lactose may represent essentially 100% of the carbohydrate content. Other carbohydrates such as saccharose, maltodextrin, and starch may be also added. However, in a preferred embodiment there may be included in the nutritional composition of the invention carbohydrates that preferably act as prebiotics. For example, prebiotics are preferably selected from 2′Fucosyllactose, Lacto-difucotetraose, 3Fucosyllactose, Lacto-N-fucopentaose I, Lacto-N-fucopentaose II, Lacto-N-fucopentaose III, Lacto-N-neotetraose, Lacto-N-tetraose, 3′Sialyllactose, 6′Sialyllactose, 3′Sialyllacto-N-tetraose, 6′Sialyl-Lacto-N-neotetraose, inulin, fructooligosaccharides (FOS), short-chain fructooligosaccharide (short chain FOS), galacto-oligosaccharides (GOS), xylooligosaccharides (XOS), gangliosides, partially hydrolyzed guar gum, acacia gum, soybean-gum, or mixtures thereof.

The carbohydrate or carbohydrates may be present at about 1g to 20g or 1% to 80% or 20% to 60% in the daily doses of the composition. Alternatively, the carbohydrates are present at 10% to 80% of the dry composition, for an example, in an amount of 9 to 14 g/100 kcal.

In a preferred embodiment, lactose represents more than 98% of the carbohydrate present in the composition.

In one embodiment, the nutritional composition comprises a mix of oligosaccharides according to WO2007/090894 (general teaching and specifically Example 1). It may be in particular used in combination with GOS. The base formula may provide an oligosaccharide mixture which comprises 5-70 wt % of at least one N-acetylated oligosaccharide selected from the group comprising GalNAcα1,3Galβ1,4Glc and Galβ1,6GalNAcα1,3Galβ1,4Glc, 20-90 wt % of at least one neutral oligosaccharide selected from the group comprising Galβ1,6Gal, Galβ1,6Gaβ1,4Glc Galβ1,6Galβ1,6Glc, Galβ1,3Gaβ1,3Glc, Galβ1,3Gaβ1,4Glc, Galβ1,6Galβ1,6Galβ1,4Glc, Galβ1,6Galβ1,3Galβ1,4Glc Galβ1,3Galβ1,6Galβ1,4Glc and Galβ1,3Galβ1,3Galβ1,4Glc and 5-50 wt % of at least one sialylated oligosaccharide selected from the group comprising NeuAcα2,3Galβ1,4Glc and NeuAcα2,6Galβ1,4Glc.

Other components may be added to a nutritional composition, such as vitamins and minerals.

If necessary, the composition of the invention may contain emulsifiers and stabilizers such as soy, lecithin, citric acid esters of mono- and di-glycerides, and the like.

The composition may also contain other substances which may have a beneficial effect such as lactoferrin, nucleotides, nucleosides, gangliosides, polyamines and the like. The nutritional composition may further comprise flavours such as but not limited to vanillin.

A particular preferred embodiment relates to a nutritional composition further comprising fructo-oligosaccharides such as raftiline and/or raftilose.

The nutritional composition, such as a follow on infant formula or GUM, may be a liquid formula or a powder that is to be reconstituted before use. A preferred embodiment is a follow on infant formula being a powder.

In a preferred embodiment, the nutritional composition is a liquid composition that has been prepared by reconstituting a powder.

In a preferred embodiment, the nutritional composition is a liquid composition, for example a liquid growing up milk (GUM).

The nutritional composition may also comprise all vitamins and minerals understood to be essential in the daily diet in nutritionally significant amounts. Minimum requirements have been established for certain vitamins and minerals. Examples of minerals, vitamins and other nutrients present in the nutritional composition include vitamin A, vitamin B1, vitamin B2, vitamin B6, vitamin E, vitamin K, vitamin C, vitamin D, folic acid, inositol, niacin, biotin, pantothenic acid, choline, calcium, phosphor, iodine, iron, magnesium, copper, zinc, manganese, chloride, potassium, sodium, selenium, chromium, molybdenum, taurine, and L-carnitine. The minerals are usually added in the salt form.

### Preparation of Nutritional Compositions

The nutritional compositions according to the present invention may be prepared by any known or otherwise suitable manner.

Of course, the protein component is that described above comprising a2-β-casein that represents more than 50%, preferably, more than 70%, more preferably, more than 90%, even more preferably, 95%, or most preferably 100% of total βcaseins in the composition.

For example, a growing up milk may be proposed by blending together a suitable source of protein with a carbohydrate source and a lipid source in appropriate proportions. If used, emulsifiers may be included at this stage. Vitamins and minerals may be added at this stage, but may also be added later to avoid thermal degradation. Water, preferably water which has been subjected to reverse osmosis or deionized water, may then be added and mixed in to form a liquid mixture. The temperature of mixing is preferably room temperature, but may also be higher. The liquid mixture may then be thermally treated to reduce bacterial loads. The mixture may then be homogenized.

If it is desired to produce a powdered composition, the homogenized mixture is dried in a suitable drying apparatus, such as a spray drier or freeze drier and converted into powder.

Processes used in the manufacture of formulae for infants and young children are based on the concept that the products must be nutritionally adequate and microbiologically safe to consume. Thus, steps that eliminate or restrict microbiological growth are central to production processes. The processing technology for each specific formula is proprietary to the manufacturer but, in general, it involves the preservation of an oil-in-water (o/w) emulsion by dehydration in the case of powder products or, sterilization in the case of ready-to-feed or concentrated liquid products. Powdered infant formula may be produced using various processes, such as dry blending dehydrated ingredients to constitute a uniform formula or hydrating and wet-mixing a mixture of macro-ingredients, such as fat, protein and carbohydrate ingredients and then evaporating and spray drying the resultant mixture. A combination of the two processes described above may be used where a base powder is first produced by wet-mixing and spray drying all or some of the macro-ingredients and then dry blending the remaining ingredients, including carbohydrate, minerals and vitamins and other micronutrients, to create a final formula. Liquid formulae are available in a ready-to-feed format or as a concentrated liquid, which requires dilution, normally 1:1, with water. The manufacturing processes used for these products are similar to those used in the manufacture of recombined milk.

If it is desired to produce a liquid infant formula, the homogenized mixture is filled into suitable containers, preferably aseptically. However, the liquid composition may also be retorted in the container, suitable apparatus for carrying out the filling and retorting of this nature is commercially available.

### Therapeutic uses of a2-β-casein-Dominant Nutritional Compositions or Nutritional Compositions having a Reduced Proteose Peptone Content

The inventors have shown in a clinical trial that young children had improved temperament after consuming nutritional compositions according to embodiments of the invention. Example 1 describes a clinical trial that carried out showing the positive effect of the nutritional compositions of the invention on young children's temperament.

The statistically significant results indicate that a2-β-casein dominant nutritional composition that was administered improved temperament in the young children studied compared to the control composition. Specifically, administration of the a2-β-casein dominant nutritional composition reduced irritability in the young children. It also increased the ability of the infant, toddler or young child to self sooth or to be soothed by a care giver. Administration of the a2-β-casein dominant nutritional composition also increased the sociability of the young children.

According to particular embodiments, the young child is at an age between 12 months and 6 years.

The clinical trial reported herein was designed to remove bias due to character differences in the group. The randomized design of the study controls for potential bias from a character difference between the two groups. The subjects were selected at random to participate in either the A2 GUM or non-A2 groups. Any character distribution should be similar between the randomized groups. Therefore, the effects that were seen could be attributed to the difference of composition of the GUM composition administered.

The children receiving the A2 milk product displayed significantly better temperament compared to those receiving a standard A1/A2 GUM.

The data was analysed to determine if the positive effect on temperament seen in the young children was due to any potential increased gut comfort that could be induced by the a2-β-casein-dominant GUM compared to a A1/a2-β-casein containing control composition. reducing the irritability shows a schematic diagram that demonstrates that the temperament effect is not correlated with the gut comfort effect.

Therefore, the positive effect on temperament observed by the applicants is independent of and distinct from any potential gut comfort effect.

### Administration Period

The period of administration of the nutritional compositions of the invention can be continuous or discontinuous. Continuous administration is preferred for a more sustained effect. Typically, the nutritional composition may be administered at least twice a day, preferably three times a day.

However, it is speculated that a discontinuous pattern (for example, three times daily administration during alternate days) can nevertheless induce positive effects on the young mammal.

In general, while positive effects are expected with relatively short duration of administration (for example, daily administration during one to four weeks), longer durations are believed to provide enhanced effect (for example, a duration of at least three to six months in humans, preferably for at least one year, and corresponding periods in other mammals).

In an embodiment of the invention, the nutritional composition is intended for consumption by an infant or toddler. In this case, consumption may begin at 12 months old and may continue from then until any age, until the age of approximately 36 months old.

In an embodiment of the invention, the nutritional composition is intended for consumption by a young child. In this case, consumption may start from the age of three years old, or from the age of 4, or 5, or 6 years old, or any age until the age of approximately 7 years old. The invention will now be described in further details in the following non-limiting examples.

### EXAMPLES

### Example 1 Clinical Study

The primary objective was to compare overall digestive comfort between toddlers age 12-36 months consuming GUM containing only A2-β-casein (A2 GUM) and those consuming traditional non-A2 milk products over a 2-week study period.

### Study Design

The study was a multi-center, uncontrolled, post-market study of toddlers age 12 to 36 months who met the study inclusion and exclusion criteria. A total 387 subjects enrolled in the trial (259 in the A2 GUM group and 128 in the Non-A2 GUM group). Subjects were allocated to receive A2 GUM (Wyeth Illuma Atwo growing-up milk, currently commercially available in China, see example 2), a Comparator A2 GUM (a2 Platinum® Toddler milk drink, see Example 3), or continuation of habitual non-A2 milks. Subjects were randomly assigned to each arm using an allocation schedule determined a priori. On Study Day 1, subjects were dispensed the assigned study GUM (for the A2 GUM or Comparator A2 GUM groups) or instructed to have their child continue the habitual feeding regimen of non-A2 milks and milk products (traditional non-A2 milk group). Three daily servings of A2 GUM or Comparator A2 GUM were dispensed and caregivers were instructed to provide the study GUMs for 14 days. Subjects and caregivers attended 2 clinic visits on Study Days 1 and 15 and completed study questionnaires on Study Days 1, 5-7 and 12-14. The primary outcome measure for this study was the Gut Comfort Composite Score (GCS), derived from the nine-item Toddler Gut Comfort Questionnaire. The potential range for the GCS is 10 to 60 with higher scores indicating higher GI burden. The baseline assessment was derived from one 24-hour recall of the previous day, and assessments for Study Day 7 and 14 were derived from average values from 3 consecutive days on days 5-7 and 12-14, respectively. Secondary outcomes for this study included 1) individual GI symptoms/behaviors frequency and severity scores, 2) stool frequency and stool consistency scores, 3) milk intake (type and volume), 4) milk satisfaction scores, 5) anthropometry (weight, height, head circumference, and corresponding anthropometric Z-scores), and 6) child temperament. In the results section, A2 GUM refers to the combined A2 GUM groups.

Toddler and child temperament, was assessed via parent report using a short version of the Early Childhood Behavior Questionnaire (ECBQ), which has been validated across several studies and used in the Chinese population. This questionnaire included 9 questions covering several behavioral domains such as Fear, Frustration, Impulsivity, Sociability, Soothability, Sadness and Shyness. The questionnaire was administered at Study Day 14 to all of the subjects. ANOVA was used to assess differences in the behavioral domains between the A2 GUM and non-A2 milk groups. Post hoc, correlations were also computed and displayed using a scatterplot matrix between each of the individual measures in the GCS and the individual temperament measures, and a canonical correlation was calculated overall.

### Study Results—Temperament

TABLE 1
Temperament questionnaire at Day 14 (FAS)

| | A2 GUM | | | | | Non-A2 milk | | | | | |
|---|---|---|---|---|---|---|---|---|---|---|---|
| Question (1—Never; 6: Always) | n | mean | sd | min | max | n | mean | sd | min | max | p-value |
| Irritability: While having trouble completing a task | 234 | 5.2 | 1.44 | 1 | 7 | 115 | 5.4 | 1.61 | 1 | 7 | 0.661 |
| (e.g., building, drawing, dressing), | | | | | | | | | | | |
| how often did your child get easily irritated? | | | | | | | | | | | |
| Sociability: When a familiar child came to your home, | 231 | 4.5 | 1.84 | 1 | 7 | 114 | 4.2 | 1.86 | 1 | 7 | 0.047 |
| how often did your child seek out | | | | | | | | | | | |
| the company of the child? | | | | | | | | | | | |
| Attention focusing: When engaged in play with his/her | 232 | 4.8 | 1.82 | 1 | 7 | 113 | 4.5 | 1.91 | 1 | 7 | 0.061 |
| favorite toy, how often did your | | | | | | | | | | | |
| child play for more than 10 minutes? | | | | | | | | | | | |
| Effortful control: During everyday activities, how | 229 | 4.8 | 1.73 | 1 | 7 | 115 | 4.5 | 1.89 | 1 | 7 | 0.099 |
| often did your child pay attention to | | | | | | | | | | | |
| you right away when you called to him/her? | | | | | | | | | | | |
| Irritability: When s/he asked for something and you | 234 | 4.2 | 1.62 | 1 | 7 | 114 | 4.5 | 1.61 | 1 | 7 | 0.372 |
| said “no”, how often did your child | | | | | | | | | | | |
| have a temper tantrum? | | | | | | | | | | | |
| Activity level: While playing indoors, how often | 232 | 3.1 | 1.72 | 1 | 7 | 114 | 3.4 | 1.84 | 1 | 7 | 0.030 |
| did your child run through the house? | | | | | | | | | | | |
| Sociability: When a familiar adult, such as a relative | 233 | 4.9 | 1.70 | 1 | 7 | 114 | 4.7 | 1.78 | 1 | 7 | 0.028 |
| or friend, visited your home, how | | | | | | | | | | | |
| often did your child want to interact with the adult? | | | | | | | | | | | |
| Soothability: When s/he was upset, how often did | 234 | 5.1 | 1.56 | 1 | 7 | 115 | 5.2 | 1.43 | 1 | 7 | 0.989 |
| your child cry for more than 3 | | | | | | | | | | | |
| minutes, even when being comforted? | | | | | | | | | | | |
| Soothability: When s/he was upset, how often did | 230 | 4.5 | 1.63 | 1 | 7 | 115 | 4.2 | 1.64 | 1 | 7 | 0.004 |
| your child become easily soothed? | | | | | | | | | | | |

FAS=full analysis set. Differences in mean temperament measures at day 14 were analyzed using ANOVA. Of the nine temperament questions, there were 4 significant differences in mean score between the A2 GUM and non-A2 milk groups at day 14. The A2 GUM group reported higher average sociability (“When a familiar child came to your home, how often did your child seek out the company of the child?” and “When a familiar adult, such as a relative or friend, visited your home, how often did your child want to interact with the adult?”) and soothability (“When s/he was upset, how often did your child become easily soothed?”) scores compared to the non-A2 milk group, (3 questions, p<0.05 in all cases) but reported a lower average activity level (“While playing indoors, how often did your child run through the house?”) score (p=0.03).

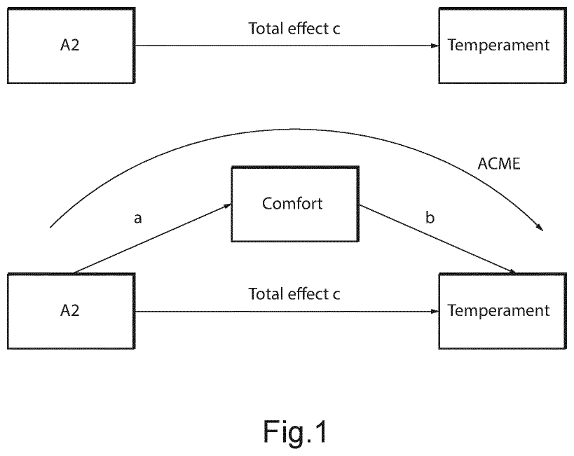

Further data exploration was carried out to study whether the effects seen in temperament were mediated through the positive benefit on Gut Comfort. The Gut Comfort Questionnaire and Temperament were summarized by Principal Component Scores, which is a weighted sum of the questionnaire scores, where the weights are chosen in a way to maximize the treatment effect. FIG. 1 shows a schematic diagram of the results of this data analysis.

TABLE 2

| | Estimate | 95% CI | p-value |
|---|---|---|---|
| ACME | −0.019 | −0.097, −0.097 | 0.51 |
| ADE | 0.725 | 0.170, 1.276 | 0.008 |
| Total Effect (c) | 0.706 | 0.158, 1.253 | 0.01 |

As seen in Table 2, the mediation analysis showed that effect of A2 on temperament is not influenced by the Gut Comfort variable (p=0.51). Instead, A2 GUM has direct effect on temperament, which is statistically significant (p=0.008). In addition, when evaluating the total effect of A2 on temperament, the effect remains stable (0.725 vs. 0.706), further supporting that the effect of A2 on Temperament is independent of the effects on Gut Comfort.

Therefore, the improved temperament observed after administration of the A2 GUM may not be characterized as a side-effect of improved gut comfort. The effects are distinct and not correlated.

### Example 2

### Illuma® A2 Stage 3 Milk Containing a2-β-casein

| Nutrient | Per litre | Per 100 g of powder |
|---|---|---|
| Energy (kcal) | 740 | 437 |
| Protein (g) | 24 | 13.9 |
| Whey (g) | 9.4 | 5.6 |
| Of which α-Lactalbumin (g) | 1.3 | 0.74 |
| Casein (g) | 14 | 8.3 |
| Fat (g) | 25 | 14.8 |
| sn-2 Palmitate (g) | 4.2 | 2.5 |
| Linoleic acid (g) | 4.9 | 2.9 |
| α-Linolenic acid (g) | 0.47 | 0.28 |
| Arachidonic acid (mg) | 26 | 15 |
| Docosahexaenoic acid (mg) | 85 | 50 |
| Available carbohydrates (g) | 105 | 62.1 |
| Soluble Dietary Fiber (as | 3.0 | 1.8 |
| oligofructose) (g) | | |
| Moisture (g) | 870 | 3.0 |
| Ash (Minerals) (g) | 7.4 | 4.4 |
| Ca:P ratio | 1.5 | 1.5 |
| Ca (mg) | 690 | 409 |
| P (mg) | 460 | 274 |
| Mg (mg) | 52 | 31 |
| Fe (mg) | 9.1 | 5.4 |
| Zn (mg) | 5.4 | 3.2 |
| Mn (μg) | 300 | 179 |
| Cu (mg) | 0.28 | 0.17 |
| I (μg) | 100 | 60 |
| Na (mg) | 520 | 309 |
| K (mg) | 960 | 568 |
| Cl (mg) | 510 | 304 |
| Se (μg) | 17 | 10 |
| Lutein (mg) | 0.22 | 0.13 |
| Choline (mg) | 180 | 108 |
| Vitamin A (μg RE) | 670 | 396 |
| β-Carotene (μg) | 150 | 89 |
| Vitamin D (μg) | 13 | 7.6 |
| Vitamin E (mg α-TE) | 5.1 | 3.0 |
| Vitamin K (μg) | 55 | 33 |
| Vitamin B1 (mg) | 0.61 | 0.36 |
| Vitamin B2 (mg) | 1.0 | 0.59 |
| Vitamin B6 (mg) | 0.47 | 0.28 |
| Vitamin B12 (μg) | 2.1 | 1.2 |
| Niacin (mg) | 5.0 | 3.0 |
| Folic acid (μg) | 150 | 89 |
| Pantothenic acid (mg) | 4.0 | 2.4 |
| Biotin (μg) | 16 | 9.5 |
| Vitamin C (mg) | 120 | 71 |

### Example 3

### Platinum® Toddler Milk Drink, Containing a2-β-casein, Available from the A2 Milk Company (Auckland, Australia).

| Nutrient | Per litre |
|---|---|
| Energy (kJ) | 2920 |
| Protein (g) | 27 |
| Whey protein (g) | 11 |
| Casein protein (g) | 17 |
| Of which A2 beta-casein (g) | 5.3 |
| Carbohydrate (g) | 78.4 |
| Dietary Fiber (g) | 4 |
| Of which Galacto-oligosaccharide (g) | 4 |
| Fat, total (g) | 29 |
| Saturated fat (g) | 10 |
| Trans fat (g) | <1 |
| Monounsaturated fat (g) | 10 |
| Polyunsaturated fat (g) | 8 |
| Omega-3 (mg) | 960 |
| Of which α-linolenic acid (mg) | 780 |
| Of which docosahexaenoic acid (mg) | 160 |
| Omega-6 (g) | 6.81 |
| Of which linoleic acid (g) | 6.71 |
| Vitamin A (μg RE) | 390 |
| Vitamin D (μg) | 7.6 |
| Vitamin E (mg α-TE) | 15 |
| Thiamin (Vitamin B1) (mg) | 1.26 |
| Riboflavin (Vitamin B2) (mg) | 2.39 |
| Vitamin B6 (mg) | 1.46 |
| Vitamin B12 (μg) | 3.7 |
| Niacin (Vitamin B3) (mg) | 12.10 |
| Folic acid (μg) | 160 |
| Vitamin C (ascorbic acid) (mg) | 120 |
| Na (mg) | 270 |
| Ca (g) | 1.04 |
| I (μg) | 180 |
| Fe (mg) | 16 |
| Mg (mg) | 120 |
| P (mg) | 720 |
| Zn (mg) | 5.7 |

### Example 4

### Illuma® A2 Stage 2 Milk Containing a2-β-casein

| Nutrient | Per litre | Per 100 g of powder |
|---|---|---|
| Energy (kcal) | 670 | 474 |
| Protein (g) | 22 | 15.3 |
| Whey (g) | 8.6 | 6.1 |
| Of which α-Lactalbumin (g) | 1.3 | 0.92 |
| Casein (g) | 13 | 9.2 |
| Fat (g) | 30 | 21.3 |
| sn-2 Palmitate (g) | 3.5 | 2.5 |
| Linoleic acid (g) | 4.2 | 3.0 |
| α-Linolenic acid (g) | 0.42 | 0.30 |
| Arachidonic acid (mg) | 110 | 81 |
| Docosahexaenoic acid (mg) | 110 | 81 |
| Available carbohydrates (g) | 78 | 55.3 |
| Soluble Dietary Fiber (as | 3.0 | 2.1 |
| oligofructose) (g) | | |
| Moisture (g) | 900 | 2.5 |
| Ash (Minerals) (g) | 5.0 | 3.5 |
| Ca:P ratio | 1.5 | 1.5 |
| Ca (mg) | 610 | 431 |
| P (mg) | 410 | 289 |
| Mg (mg) | 68 | 48 |
| Fe (mg) | 9.6 | 6.8 |
| Zn (mg) | 4.8 | 3.4 |
| Mn (μg) | 280 | 198 |
| Cu (mg) | 0.23 | 0.17 |
| I (μg) | 80 | 57 |
| Na (mg) | 400 | 284 |
| K (mg) | 720 | 510 |
| Cl (mg) | 580 | 411 |
| Se (μg) | 15 | 11 |
| Lutein (mg) | 0.18 | 0.13 |
| Choline (mg) | 160 | 115 |
| Vitamin A (μg RE) | 590 | 418 |
| β-Carotene (μg) | 150 | 106 |
| Vitamin D (μg) | 11 | 7.9 |
| Vitamin E (mg α-TE) | 5.4 | 3.8 |
| Vitamin K (μg) | 44 | 31 |
| Vitamin B1 (mg) | 0.51 | 0.36 |
| Vitamin B2 (mg) | 1.1 | 0.80 |
| Vitamin B6 (mg) | 0.40 | 0.28 |
| Vitamin B12 (μg) | 1.4 | 1.0 |
| Niacin (mg) | 4.3 | 3.0 |
| Folic acid (μg) | 110 | 76 |
| Pantothenic acid (mg) | 2.8 | 2.0 |
| Biotin (μg) | 12 | 8.5 |
| Vitamin C (mg) | 72 | 51 |

Sequence listing
(amino acid sequence of A2 β-casein):

SEQ ID NO. 1

RELEELNVPG EIVESLSSSE ESITRINKKI EKFQSEEQQQ
TEDELQDKIH PFAQTQSLVY PFPGPIPNSL PQNIPPLTQT
PVVVPPFLQP EVMGVSKVKE AMAPKHKEMP FPKYPVEPFT
ESQSLTLTDV ENLHLPLPLL QSWMHQPHQP LPPTVMFPPQ
SVLSLSQSKV LPVPQKAVPY PQRDMPIQAF LLYQEPVLGP
VRGPFPIIV
(amino acid sequence of A1 β-casein):

SEQ ID NO.2

RELEELNVPG EIVESLSSSE ESITRINKKI EKFQSEEQQQ
TEDELQDKIH PFAQTQSLVY PFPGPIHNSL PQNIPPLTQT
PVVVPPFLQP EVMGVSKVKE AMAPKHKEMP FPKYPVEPFT
ESQSLTLTDV ENLHLPLPLL QSWMHQPHQP LPPTVMFPPQ
SVLSLSQSKV LPVPQKAVPY PQRDMPIQAF LLYQEPVLGP
VRGPFPIIV

1. A method for improving the temperament of a young mammal comprising the step of administering a nutritional composition to an infant or toddler comprising a2-β-casein, wherein the a2-β-casein represents more than 50% of total β-caseins, for use, in particular in infants older than 12 months, toddlers and young children.

2. The method of claim 1, wherein the β-caseins are provided in the form of a whey protein fraction having a reduced (3-casein derived proteose peptone content.

3. The method of claim 1, wherein said proteose peptone content is at the most 9% by weight based on total protein in the nutritional composition.

4. The method of claim 2, wherein said proteose peptones are PP8 fast, PP8 slow and/or PP-5.

5. The method of claim 1 for use in reducing the irritability of the infant, toddler or young child.

6. The method of claim 1 for use in increasing the ability of the infant, toddler or young child to self sooth or to be soothed by a care giver.

7. The method of claim 1 for use in increasing the sociability of the infant, toddler or young child.

8. The method of claim 1, wherein the infant, toddler or young child suffers from gut related pain, constipation or colic.

9. The method of claim 1, wherein the infant, toddler or young child does not suffer from gut related pain, constipation or colic.

10. The method of claim 1, wherein the composition also comprises one or more prebiotics.

11. The method of claim 10, wherein the one or more prebiotics are selected from the group consisting of fructooligosaccharides (FOS), raftilose, inulin, raftiline, lactulose, cows' milk oligosaccharides (CMOS) and galactooligosaccharides (GOS), human milk oligosaccharides (HMOS).

12. The method of claim 1, wherein the composition also comprises one or more probiotics.

13. The method of claim 7, wherein the one or more probiotics are selected from the group consisting of Lactobacillus rhamnosus, Lactobacillus paracasei and Lactobacillus reuteri and Bifidobacterium such as Bifidobacterium lactis, Bifidobacterium breve and Bifidobacterium longum.

14. The of claim 1, wherein the composition is in the form of a follow on infant formula or a growing up milk.

15. The method of claim 1, wherein a2-β-casein is SEQ ID no 1.
